(19) United States
(12) Patent Application Publication
(10) Pub. No.: US 2012/0199082 A1
(43) Pub. Date: Aug. 9, 2012

(54) Wearable Wound-Covering for a Quadruped Animal

(76) Inventor: Linda Elizabeth Dick, Sanderstead (GB)

(21) Appl. No.: 13/390,258

(22) PCT Filed: Aug. 13, 2010
(86) PCT No.: PCT/GB10/01545

§ 371 Date: Apr. 25, 2012

(30) Foreign Application Priority Data
Aug. 14, 2009 (GB) 0914304.1

(51) Int. Cl. A61D 9/00; A01K 13/00

(52) U.S. Cl. 119/850

(57) ABSTRACT

A variable wound-covering for a quadruped animal is arranged to substantially cover the abdomen of the animal and includes at least one front leg aperture for accommodating the front legs of the animal. The covering is providing with back fastening means arranged to releasably fasten the covering along the back of the animal to define a head aperture separate from the at least one front leg aperture. The wound-covering may comprise a wound-facing portion arranged to at least partly overlie the to abdomen of the animal. The wound-facing portion may comprise an absorbent material and/or a waterproof material.

### FIELD

This invention relates to a wearable wound-covering for a quadruped animal, such as a domestic dog.

### BACKGROUND

Household pet animals that sustain injury or undergo surgery have a tendency to lick, chew or disturb in some other way the resulting wound. This can delay or even prevent the healing of the wound and may lead to complications, such as the wound becoming infected. This problem is not confined to pets but also affects other animals, such as zoo animals, livestock or even wild animals, that have been injured or are recovering from surgery.

One solution that has been proposed for addressing this problem is to fit the recovering animal with a collar in the form of a frusto-conical cone that projects forwards, with increasing radius, from the animal's neck. Such cones, called “buster collars”, act as a barrier against the animal licking or chewing a wound. There are several drawbacks with buster collars: they are cumbersome for the animal to wear; they reduce the animal's peripheral vision and so give rise to a risk of the animal walking or running into surrounding structure and possibly aggravating the existing injury or sustaining further injury; and they can be difficult to fit to the animal.

One attempt to address these drawbacks is represented by the MEDICAL PET SHIRTS (RTM) offered by Medical Pet Shirts of Spectrumsingel 161, 2718 JR Zoetermeer, Zuid-Holland, The Netherlands. Each shirt is a close-fitting tube of cloth with front leg holes therein that can be pulled over the head and body of the recovering animal, such that the animal's head protrudes from one end of the tube, its legs and tail protrude from the other end, and its front legs protrude from the front leg holes. Such shirts go some way to addressing the drawbacks of the buster collar, but suffer from drawbacks of their own. For example, it can be difficult to fit one of these shirts to an animal that is reluctant to wear it. Fitting may also disturb the wound and therefore cause the animal pain.

Accordingly, there is a need for an alternative solution.

### SUMMARY

According to a first aspect of this invention, there is provided a wearable wound-covering for a quadruped animal, the covering arranged to substantially cover the to abdomen of the animal and including therethrough at least one front leg aperture for accommodating the front legs of the animal, wherein the covering is provided with back fastening means arranged to releasably fasten the covering along the back of the animal to define a head aperture, separate from the at least one front leg aperture, for accommodating the head.

By providing back fastening means that fasten the covering along the back of the animal to define a separate head aperture, the covering is much easier to fit to the animal. It can also be fitted without disturbing the wound. This is done by placing the front legs through the at least one front leg aperture and then pulling the covering up those legs to bring the covering into contact with the animal's abdomen. In this way, the abdomen can be covered without pulling the covering along the abdomen, which may disturb an abdominal wound and so cause the animal discomfort or injury. The fitting process can then be completed by fastening the back fastening means to define the head aperture around the animal's head, without the need for pulling the covering over the animal's head. Avoiding the need to pull the covering over the animal's head reduces the likelihood of the animal resisting the fitting of the covering: animals do not generally like to have their heads covered and usually resist attempts to do so. To remove the covering, the procedure can be reversed. During removal, again, aggravation of the wound is minimised and stress caused by pulling the covering over the animal's head is avoided. Providing a separate head and front leg aperture, that is with at least some structure between the two, assists in locating the covering in the desired position on the animal and in avoiding it becoming dislodged during use.

The covering may include front fastening means that releasably fasten together parts of the covering to define the at least one front leg aperture. The covering may be arranged such that the front fastening means also partly form the head aperture. The covering may be arranged such that the front fastening means fasten together parts of the covering between the at least one front leg aperture and the head aperture, thereby separating the head aperture from the at least one front leg aperture.

The covering may be arranged such that fastening the back fastening means also defines a tail aperture for accommodating the tail of the animal. The covering may include at to least one back leg aperture for accommodating the back legs of the animal. The tail aperture may be separate from the at least one back leg aperture. The covering may include additional fastening means and be arranged such that the additional fastening means fasten together parts of the covering between the at least one back leg aperture and the tail aperture, thereby separating the tail aperture from the at least one back leg aperture.

As not all animals have a tail, the covering may not have a tail aperture. The covering may be arranged such that the at least one back leg aperture is formed by fastening the back fastening means. The covering may include back fastening means that releasably fasten together parts of the covering to define the at least one back leg aperture.

The covering may be arranged such that there are two front leg apertures.

The covering may be arranged such that there are two back leg apertures.

The back fastening means may fasten together the covering between the tail aperture, or the at least one back leg aperture, and the head aperture, and may define those apertures. The back fastening means may fasten together the covering to form substantially a seam between the tail aperture, or the at least one back leg aperture, and the head aperture. The back fastening means and/or the front fastening means and/or the additional fastening means may include one or more of press-studs, hook-and-loop-type fasteners, buttons, a zip, magnetic fastenings or an adhesive.

The covering may be formed at least partly from a breathable material. It may be formed from a resiliently stretchable material. It may be formed from a material that is resiliently stretchable in two dimensions.

The covering may include a wound-facing portion that, in one embodiment, extends at least partly between the at least one front leg aperture and the at least one rear leg aperture or the tail aperture. The wound-facing portion may comprise absorbent material arranged to absorb fluid from the wound. The absorbent material may also be padded. The absorbent material may comprise towelling material. The absorbent to material may be fitted to the remainder of the covering to form a gusset therein. The absorbent material may be fitted to the breathable material, the breathable material forming an outer body portion of the covering, and the absorbent material forming a gusset therein. The wound-facing portion may be positioned so as to overlie other parts of the animal's body.

Some or all of the absorbent material may have a waterproof material fitted over the back thereof. The waterproof material may lie face-to-face across the back of the absorbent material; it may lie face-to-face across the back of the breathable material. The waterproof material may be fitted over the back of the absorbent material to form, with the absorbent material, the gusset. The waterproof material and the towelling material may be joined together around their edges; they may be joined together and to the outer body portion around their edges. The waterproof material may be a flexible waterproof material, such as, for example, a plastic film.

By providing an absorbent material in this way, leakage from the wound can be absorbed; and, in the event that the absorbent material is padded, discomfort to the animal when lying down can be reduced. By providing a waterproof material in this way, the covering guards against fluid from the wound leaking out of the covering.

According to a second aspect of this invention, there is provided a wearable wound-covering for a quadruped animal, the covering arranged to substantially cover the abdomen of the animal and comprising a wound-facing portion arranged to at least partly overlie the abdomen of the animal, the wound-facing portion comprising an absorbent material and/or a waterproof material.

Features of the first aspect of the invention may also be features of the second aspect.

### BRIEF DESCRIPTION OF THE DRAWINGS

Specific embodiments of the covering in which the invention is embodied are described below by way of example only and with reference to the accompanying drawings, in which:

FIG. 1 is a perspective view of the covering fitted to a dog;

FIG. 2 is a plan view of the covering laid out flat, the view being of the inside of the covering; and

FIG. 3 is a sectional, diagrammatic, view through a part of the covering, the section being taken at the line III-III shown on FIG. 2.

### SPECIFIC DESCRIPTION OF EXAMPLE EMBODIMENTS

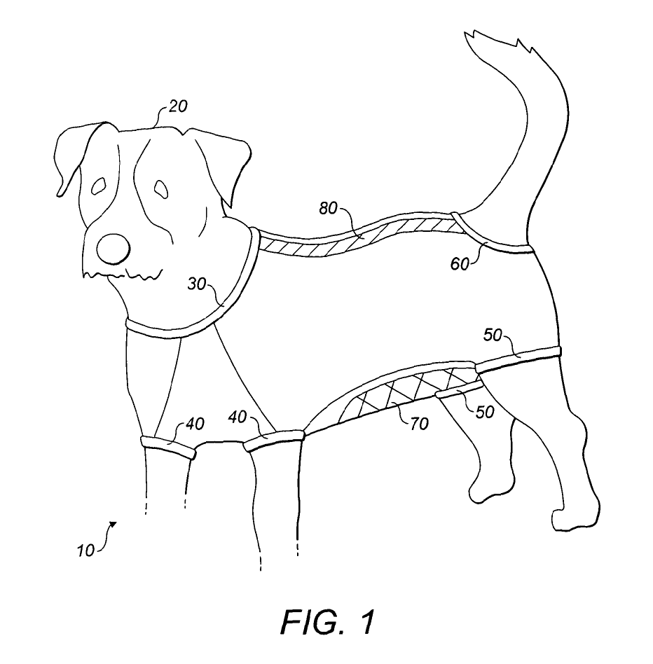

FIG. 1 shows a wearable wound-covering in the form of a suit 10 fitted to a dog 20. The suit 10 is for covering an abdominal wound (not shown) of the dog 20 and for protecting that wound from being disturbed by the dog or by surrounding structure.

With continued reference to FIG. 1, the suit 10 has a head aperture 30 for accommodating the dog's head, two front leg apertures 40 for accommodating the dog's front legs, two back leg apertures 50 for accommodating the dog's back legs, a tail aperture 60 for accommodating the dog's tail, a gusset 70 (highlighted by cross-hatching) for overlying the abdomen, and fastening means 80 (also highlighted) for fastening the suit 10 around the dog 20. These will now be described in more detail.

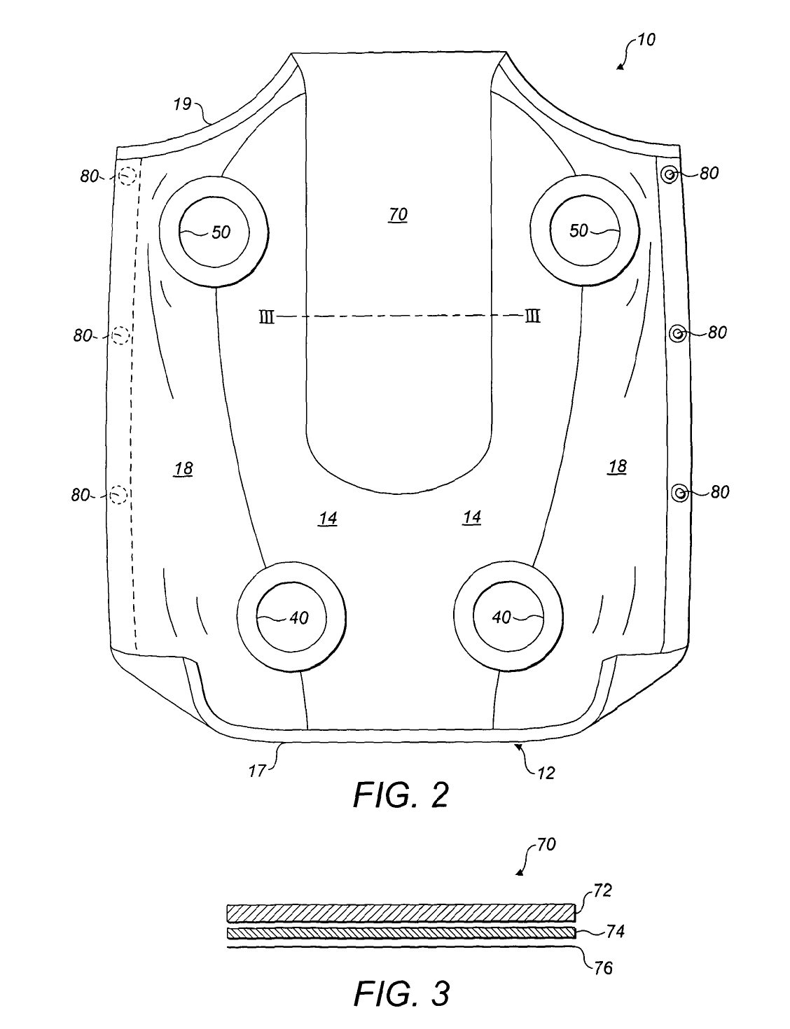

With reference to FIG. 2, a main body 12 of the suit is constructed from sewn-together panels of a breathable, stretchable material, such as LYCRA (RTM). Constructing the main body 12 from stretchable material ensures a good fit for dogs of different sizes. Constructing the main body 12 from breathable material guards against the dog overheating. The panels are shaped such that the main body 12 is a close fit to the body of the dog. The arrangement of the panels will now be described in more detail.

The main body 12 includes two underneath panels 14. These are shaped to extend underneath the dog from its chest to the base of its abdomen. These two underneath panels 14 are sewn together in the region of the chest, but are separated from each other in the region of the abdomen by the gusset 70 that extends over the abdomen. Each of the two underneath panels 14 is joined to the gusset 70 along a respective edge of the gusset 70. The construction of the gusset 16 will be described in more detail below.

The main body also includes two side panels 18. These are shaped to extend along the sides and back of the dog 20. Each side panel 18 is joined edge-to-edge along a respective one of the underneath panels 14. At the base of the suit 10, each side panel 18 is also joined to a respective edge of the gusset 70. The fastening means 80 are provided along each edge of each side panel 18 that is not joined to an underneath panel 14. The fastening means 80 will be described in more detail below.

Two arcuate cut-outs are provided in each underneath panel 14 and each side panel 18 in order to form the front leg apertures 40 and back leg apertures 50. These cut-outs are hemmed with a resiliently stretchable material such as an elasticated jersey material, to form stretchable cuffs. The end of each of the underneath panels 14 and of the side panels 18 that is front-most are together hemmed across those ends with the same (or, in other embodiments, similar) resiliently stretchable material. As will be seen, this forms a collar 17 of the suit 10 when the suit 10 is fitted to the dog 20. The end of each of the underneath panels 14 and of the side panels 18 that is rear-most, and the free end of the gusset 70, are similarly hemmed with resiliently stretchable material. As will be seen, this forms a base band 19 of the suit 10 when fitted to the dog 20.

The gusset 70 will now be described in more detail with reference to FIG. 3. As can be seen in FIG. 3, the gusset 70 is made up of three layers. An innermost one of these 72 is for lying against the abdomen of the dog 20 when the dog is wearing the suit 10. This innermost layer 72 is of a material that is absorbent and padded, although it is envisaged that, in other embodiments, this material may have just one of these characteristics. In the present embodiment, the innermost layer 72 is formed from a towelling material. The use of such a material absorbs fluid from the dog's abdominal wound. The middle layer 74 of the gusset is of a waterproof material. In other embodiments, it is envisaged that this material not be entirely impervious to water; it may instead merely resist the passage of liquid therethrough. In the present embodiment, the middle layer 74 is a flexible plastic sheet. The use of such a material tends to prevent liquid absorbed by the innermost layer 72 from leaking from the suit 10. The outermost layer 76 is a layer of the material from which the outer body 12 of the suit 10 is constructed. This serves to protect the waterproof layer, at least to some extent, from tearing or puncture.

The fastening means 18 will now be described in more detail with reference to FIG. 2. As mentioned above, and as can be seen in FIG. 2, the free edge of each side panel 18 (that is, the edge that is not joined to an underneath panel 14) is provided with fastening means 80. The fastening means 80 are provided along the length of each such free edge. In the present embodiment, the fastening means 80 take the form of press studs. A series of male press-studs 80 is provided along one of the free edges, and a series of corresponding female press-studs 80 is provided along the other of the free edges (shown as hidden detail in FIG. 2). Each one of the male press-studs 80 is positioned to mate with a respective one of the female press-studs 80 such that the two free edges of the side panels 18 overlie one another and are generally coterminous.

In order to fit the suit 10 to the dog 20, each of the dog's front paws is placed through a respective one of the front leg apertures 40, and each of the dog's back paws is placed through a respective one of the back leg apertures 50. The suit 10 is then pulled up the dog's legs, such that the gusset 70 approaches, and comes into contact with the abdomen of the dog 20 in a face-to-face manner. Once the dog's legs are fully inserted through the apertures 40, 50 and the gusset 70 is in contact with the abdomen, the press studs 80 are fastened. When this is done, the hem that lies across the front ends of the underneath panels 14 and the side panels 18 forms the collar 17 around the neck of the dog 20. Similarly, the hem that is along the rear ends of the underneath panels 14 and the side panels 18 forms the base band 19 around the tail of the dog 20. Thus, the suit 10 is fitted.

By providing an open back to the suit 10 that extends all the way from neck to base, and that can be closed to provide the collar 17 and base band 19, the suit 10 can be conveniently, and relatively painlessly, fitted to a dog recovering from abdominal injury or surgery. There are at least two reasons for this. Firstly, the described arrangement avoids the need for pulling the suit over the head of the dog 20, which can be distressing for a dog 20 and so lead it to resist the fitting of the suit 20. Secondly, the described arrangement results in the wound-facing gusset 70 approaching the wounded abdomen in a face-to-face way, rather than being dragged across the wound, thereby minimising the likelihood of disturbing the wound and hindering its healing. As a result, the described suit 10 can be quickly, conveniently and painlessly fitted to, and removed from, the dog 20.

By providing the suit 10 with the described gusset 70 that includes the towelling layer 72, the waterproof layer 74 and the backing layer 76, fluid leaking from the dog's abdominal wound can be absorbed and yet prevented from leaking from the suit 10.

1. A wearable wound-covering for a quadruped animal, the covering arranged to substantially cover the abdomen of the animal and including therethrough at least one front leg aperture for accommodating the front legs of the animal, wherein the covering is provided with back fastening means arranged to releasably fasten the covering along the back of the animal to define a head aperture, separate from the at least one front leg aperture, for accommodating the head.

2. A covering according to claim 1 wherein fastening the back fastening means also defines a tail aperture for accommodating the tail of the animal

3. A covering according to any claim 1 and including at least one back leg aperture for accommodating the back legs of the animal.

4. A covering according to claim 3, wherein the tail aperture is separate from the at least one back leg aperture.

5. A covering according to claim 1, wherein the back fastening means fastens together the covering between the tail aperture, or the at least one back leg aperture, and the head aperture, thereby at least partly defining those two apertures.

6. A covering according to claim 5, wherein the back fastening means fastens together the covering to form substantially a seam between the tail aperture, or the at least one back leg aperture, and the head aperture.

7. A covering according to claim 1 and formed at least partly from a breathable material.

8. A covering according to claim 1 and formed from a resiliently stretchable material.

9. A covering according to claim 8, wherein the covering is formed from a material that is resiliently stretchable in two dimensions.

10. A covering according to claim 2, wherein the covering includes a wound-facing portion that extends at least partly between the at least one front leg aperture and the at least one rear leg aperture or the tail aperture.

11. A covering according to claim 10, wherein the wound-facing portion comprises absorbent material arranged to absorb fluid from the wound.

12. A covering according to claim 10, wherein the wound-facing portion comprises, or the absorbent material is, padded material.

13. A covering according to claim 11, wherein the absorbent material is fitted to the remainder of the covering to form a gusset therein.

14. A covering according to any-one-of claim 11, wherein the absorbent material is fitted to the breathable material, the breathable material forming an outer body portion of the covering, and the absorbent material forming a gusset therein.

15. A covering according to claim 11, wherein some or all of the absorbent material has a waterproof material fitted over the back thereof.

16. A covering according to claim 15, wherein the waterproof material lies face-to-face across the back of the absorbent material.

17. A covering according to claim 15, wherein the waterproof material is fitted over the back of the absorbent material to form, with the absorbent material, at least part of the gusset.

18. A covering according to claim 15, wherein the absorbent material and/or the waterproof material are backed by another layer of material to at least partly protect the waterproof material and/or the absorbent material from damage.

19. A covering according to claim 11, wherein the absorbent material is a towelling material.

20. A covering according to any claim 15, wherein the waterproof material is a flexible waterproof material, such as, for example, a plastic sheet.

21. A covering according to claim 1, wherein the back fastening means include one or more of press-studs, hook-and-loop-type fasteners, buttons, a zip, magnetic fastenings and an adhesive.

22. A wearable wound-covering for a quadruped animal, the covering arranged to substantially cover the abdomen of the animal and comprising a wound-facing portion arranged to at least partly overlie the abdomen of the animal, the wound-facing portion comprising an absorbent material and/or a waterproof material.

23. A covering according to claim 22 wherein fastening the back fastening means also defines a tail aperture for accommodating the tail of the animal.
